(19) United States
(12) Patent Application Publication
(10) Pub. No.: US 2008/0028044 A1
(43) Pub. Date: Jan. 31, 2008

(54) System and method for file transfer

(75) Inventors: Russell Powers, Falls Church, VA (US); Matthew Kirk, Springfield, VA (US)

Correspondence Address: BREINER & BREINER, L.L.C., P.O. BOX 320160, ALEXANDRIA, VA, 22320-0160, US

(73) Assignee: IntelliDyne, L.L.C., Falls Church, VA (US)

(21) Appl. No.: 11/492,762

(22) Filed: Jul. 26, 2006

(51) Int. Cl. G06F 15/16

(52) U.S. Cl. 709/219; 709/217; 709/203

(57) ABSTRACT

A system or apparatus and method which provide the transfer of files in a network, thereby leveraging clients via an email is disclosed. The system or apparatus and method include a client machine readable medium, a broker server, and an attachment server. A user prepares and issues a request for a file on the client machine readable medium and sends the request to the broker server. The client machine readable medium verifies its identity with the broker server. Upon authorization by the broker server, the request is sent to the attachment server for the file requested by the client machine readable medium. A link to the requested file is sent in a transfer receipt by email from the attachment server to the client machine readable medium. The client machine readable medium invokes the attachment server and the client machine readable medium accesses the file via the link in the transfer receipt, which enables the requested file to be downloaded and received by the client machine readable medium.

### FIELD OF INVENTION

The present invention relates to a system and method for transferring files in a network, thereby leveraging clients via electronic mail (email). The system and method include a three-tiered hierarchy which handles all file transmission procedures and provides a user interface and user notification to a client via email. More particularly, the invention relates to a system and method for file transfer including a client machine readable medium, a broker server, and an attachment server.

### BACKGROUND OF INVENTION

Machine readable mediums, such as computers, are capable of creating and storing various files. In networks, files can be shared between various computers. When a network is connected to the World Wide Web, files may be retrieved through the World Wide Web. However, problems are associated with the transmission of files in this manner, such as slow transmission of data in the files from the source to the requester and complex or inadequate software for transferring files by electronic transmission such as by email. As such, a need exists for a system and method which provide for the transfer of files in a network in an easy and efficient manner.

These and other shortcomings of known art are addressed by the present invention.

### OBJECTS AND SUMMARY OF INVENTION

The present invention relates to a system or apparatus and method which provide for the transfer of files in a network, such as a local network or a non-local network like the Internet, thereby leveraging clients via an email. The system and method include a three-tiered hierarchy which handles all file transmission procedures and provides a user interface and user notification to a client via email. More particularly, the invention relates to a system and method for file transfer having at least a client machine readable medium, a broker server, and an attachment server, each of which preferably includes a machine readable medium.

In the system and method of the invention, a user prepares and issues a request for a file or files on a client machine readable medium and sends the request to the broker server. In order to send the request, the client machine readable medium verifies its identity with the broker server. If the broker server recognizes the identity of the client machine readable medium, such as by recognizing a user name and/or password, the broker server provides authorization to the request by the client machine readable medium.

Upon authorization, the broker server sends the request to the attachment server, which has a repository of files, for the file or information requested by the client machine readable medium. Upon authorization by the attachment server, the file or information requested by the client machine readable medium is sent to the client machine readable medium from the attachment server in the form of an email. More particularly, a link to the requested file or information is preferably sent by email from the attachment server to the client machine readable medium.

The client machine readable medium invokes the attachment server to enable transferring of the requested file or information via the link provided in the email from the attachment server. The email from the attachment server to the client machine readable medium is preferably a transfer receipt. More particularly, the email is sent to the client machine readable medium and the user thereby enabling the requested file or files to be downloaded and received by the client machine readable medium via the link in the transfer receipt.

An object of the present invention is to provide a system or apparatus and method which enable easy transfer of files from a repository of files to the user on a client machine readable medium which requested the file.

Another object of the present invention is to provide a system or apparatus and method of file transfer on a network, such as a local network or non-local network like the Internet, from a repository of files.

These and other objects of the invention will be apparent from the following description of the preferred embodiments of the invention and from the accompanying drawing.

### BRIEF DESCRIPTION OF THE DRAWINGS

Referring to the drawing:

FIG. 1 illustrates an embodiment of the system of the present invention.

### DETAILED DESCRIPTION OF THE PREFERRED EMBODIMENTS

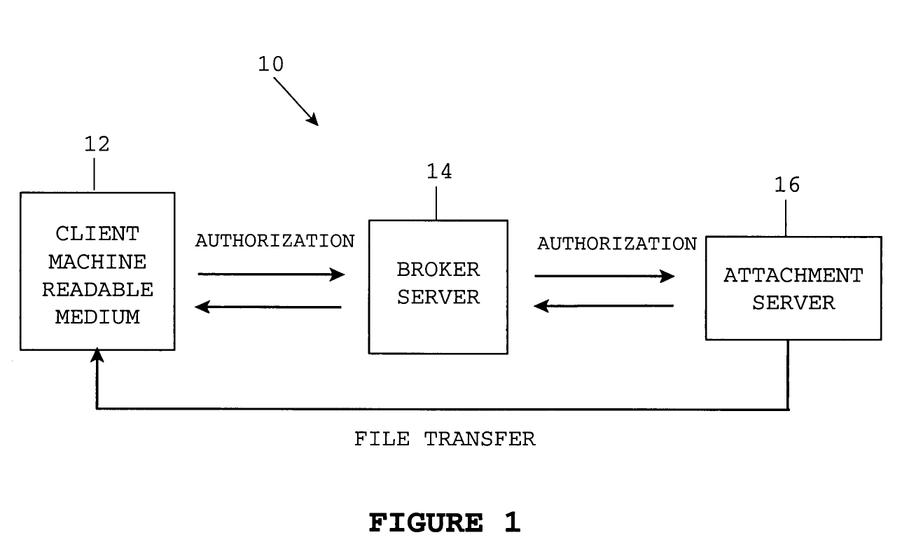

The present invention relates to a system or apparatus and method 10 which provide for the transfer of files in a network, such as a local network or a non-local network like the Internet, thereby leveraging clients via an email. The Internet is currently recognized as an electronic communications network that connects machine readable medium networks, e.g., computer networks, and organizational machine readable medium facilities, e.g., computer facilities, around the world. The system or apparatus and method 10 is a three-tiered hierarchy which handles all file transmission procedures and provides a user interface and user notification to the client via email. As shown in FIG. 1, the system or apparatus and method for file transfer include a client machine readable medium 12, a broker server 14, and an attachment server 16, each of which preferably includes a machine readable medium. A machine readable medium includes, but is not limited to, a personal computer (PC), a personal digital assistant (PDA), a network/Internet accessible cell phone or the like.

In the system or apparatus and method 10 of the invention, a user prepares and issues a request for a file or files on the client machine readable medium 12 and sends the request to the broker server 14. In order to send the request, the client machine readable medium 12 verifies its identity with the broker server 14. If the broker server 14 recognizes the identity of the client machine readable medium 12, such as by recognizing a user name and/or password, the broker server 14 provides authorization to the request by the client machine readable medium 12.

Upon authorization, the broker server 14 sends the request to the attachment server 16, which has a repository of files, for the file or information requested by the client machine readable medium 12. Upon authorization by the attachment server 16, the file or information requested by the client machine readable medium 12 is sent to the client machine readable medium 12 from the attachment server 16 in the form of an email. In a preferred embodiment, the email from the attachment server 16 to the client machine readable medium 12 includes a link to the requested file or information.

The client machine readable medium 12 invokes the attachment server 16 to enable transferring of the requested file or information via the link provided in the email from the attachment server 16. The email from the attachment server 16 is preferably a transfer receipt. More particularly, the transfer receipt is sent by email to the client machine readable medium 12 and therefore the user, thereby enabling the requested file to be downloaded through a network, such as a local network or non-local network like the Internet, and received by the client machine readable medium 12 via the link in the transfer receipt. The system and method of the invention are described in more detail hereafter.

The client machine readable medium 12, the broker server 14 and the attachment server 16 of the invention interact with each other and work independently of each other. Each component is preferably operatively included on at least one machine readable medium or on multiple machine readable mediums.

The client machine readable medium 12 preferably includes an operating system, such as Microsoft® Windows® 2000 or Microsoft® Windows® XP Work Station running on Microsoft® Office 2000, Microsoft® Office XP® or Microsoft® Office 2003. However, any suitable operating system may be included with the client machine readable medium of the system and method of the present invention.

When a user wants to receive and upload a file, the user uses a client machine readable medium 12. An icon is selected on an interface on the client machine readable medium 12. In a preferred embodiment, this icon is an XL icon. However, the icon may be designated as any suitable icon. The XL icon is preferably operatively positioned on the client machine readable medium 12 on a personal information manager. In a preferred embodiment, the personal information manager is Microsoft® Outlook® and the icon is on the Microsoft® Outlook® toolbar. However, any suitable personal information manager and icon may be used. The personal information manager interface allows users to send files via email as opposed to by hyper text transfer protocol (HTTP) or file transfer protocol (FTP). HTTP is the protocol, i.e., set of rules, for exchanging files (text, graphic images, sound, video and other multimedia files) on the World Wide Web and Internet. FTP is the language used for file transfer from computer to computer across the World Wide Web or Internet.

In using a client machine readable medium 12, a user may attach requests for multiple files without size restriction. Once a user has completed its request, the request is preferably sent by email to the broker server 14 by the user selecting the standard “send” button on the personal information manager, such as preferably on Microsoft® Outlook®. When the transfer receipt is received with the requested files, the file is uploaded on the client machine readable medium 12 via a network, such as a local network or a non-local network such as the Internet, in any suitable manner.

In a preferred embodiment, files are located on the client machine readable medium 12 and then processed to a predetermined data integrity number. This checksum is utilized to ensure the proper transmission of data and to ensure the data is correct on the receiving side. This preferably occurs by a socket being opened between the client machine readable medium 12 and the attachment server 16, which uses a globally unique identifier (GUID) sent during the request, as verification that this is the correct client machine readable medium connection. The GUID is a predetermined number that is produced by the operating system or by some application to identify a particular component, application, file, database entry, user and/or the like. All data is preferably sent over this socket.

A file description message is sent to the attachment server 16 with information such as, file name, file size, and checksum value. When this message is received by the attachment server 16, the attachment server 16 sends an acknowledgment message back notifying the client machine readable medium 12 that the attachment server 16 is poised for transmission. The user at the client machine readable medium 12 then enters a data reading loop where it passes over an entire set of bytes and places them on a network interface card or network integration card (NIC) buffer via the socket. As the data is queued, the data is sent using the TCP/IP protocol from the NIC across a network, such as a local network or non-local network such as the Internet, depending on system architecture.

The attachment server 16 monitors the NIC on the specific port the client machine readable medium socket is assigned to. Once data begins, the attachment server 16 reads the buffer on the NIC and writes the data to a file. On the client machine readable medium side, when the end of a file is completed a termination message is sent and then the client machine readable medium 12 holds awaiting successfully receipt of the aforementioned transfer. The attachment server 16 writes all data to the file, and then stops when it reads the termination sequence. The attachment server 16 runs a checksum algorithm or method and compares it to the one sent from the client machine readable medium 12 prior to transmission, if they are the same and the data on the attachment server 16 matches the data, byte for byte, that the client machine readable medium 12 intended to upload. At which point, a success receipt is sent. In case of failure, a failure receipt is sent and the client machine readable medium 12 will attempt to resend the same file.

After all files have been transferred successfully, the attachment server 16 generates a link to the file and resends the link back in a “operation successful receipt” to the client machine readable medium 12 where it is put into the email of the corresponding message. Upon a failure receipt, the client machine readable medium 12 will notify the user that numerous attempts were made to upload the files but something unexpected prevented the transfer.

However, any other suitable email program or personal information manager may be used in conjunction with the client machine readable medium 12.

In a preferred embodiment, the broker server 14 includes any suitable operating system. In a preferred embodiment, the broker server 14 operates in association with Microsoft® Windows® 2000/2003 server which is preferably operatively located in an internal part of a client's network. The broker server 14 may also be located in any other suitable location.

The broker server 14 captures a user's authentication from the client machine readable medium 12 and policy information from a directory service and passes the policy information down to the client on the client machine readable medium 12. The broker server 14 provides authorization to the request from a client machine readable medium 12 via the directory service. A preferred directory service is Microsoft® Active Directory®. However, any suitable directory service may be used. A directory service is a centralized and standardized system that automates network management of user data and security, distributes resources and enables interoperation with other directories. The policy information includes, but is not limited to, group membership for the sending client machine readable medium 12, available attachment servers 16 for uploading files and additional broker servers 14 for load balancing. Specifically, group membership for the client machine readable medium 12 is pulled from the Active Directory® and is transmitted to the client machine readable medium 12.

The system and method 10 of the invention allow system administrators to customize settings for users at the client machine readable medium 12 based on their Active Directory® group membership. As detailed above, the broker server 14 provides authorization, authentication, and load balancing between other broker servers 14 and finds available attachment servers 16 for file upload by the client machine readable medium 12.

The attachment server 16 preferably includes a web server such as Microsoft® Windows® Internet Information Service (Microsoft® Windows® IIS) located on the client's network or the network associated with the client machine readable medium 12. A link to the web server is appended to the outgoing email from the attachment server 16 to the client machine readable medium 12. The recipients of the email/attachments at the client machine readable medium 12 therefore browse the attachment server 16, such as by hyper text transfer protocol (HTTP), to download the files. Also, the attachment server 16 receives and stores files that will be downloaded by the user on the client machine readable medium 12 from an outgoing email.

The attachment server 16 receives and stores as detailed above. Additionally, files are stored on the attachment server 16 in a predetermined directory based on the attachment server configuration. The declaration of a single repository is done following installation. In this directory, a subdirectory is created for each transaction based upon the GUID generated during the request. Inside the subdirectory, each file is stored separately with the same name as stated/received from the client machine readable medium 12. Additionally, a descriptor extensible markup language (XML) file exists which contains transaction information. A list of all the files, their name, size, checksum, the date of expiration of the files based on the user's policy permissions and/or the like are set on the broker server 14, e.g., user A's files exist for 7 days while user B's files exist for 60 days.

The workflow sequence of the system and method 10 of the invention preferably operates in a manner as follows. Initially, a user prepares and issues a request on the client machine readable medium 12 and sends the request to the broker server 14. The client machine readable medium 12 verifies its identity with the broker server 14. If the broker server 14 recognizes the identity of the client machine readable medium 12, authorization is provided by the broker server 14 to the client machine readable medium 12. The request from the client machine readable medium 12 is then sent to the attachment server 16 having a repository and a link to the requested file or information is then sent from the attachment server 16 to the client machine readable medium 12. More particularly, the request from the client machine readable medium 12 invokes the attachment server 16 which provides a transfer receipt to the client machine readable medium 12, preferably in the form of an email. The transfer receipt, which is sent to the client machine readable medium 12 of the user requesting the file or information, includes a link to the requested file so that the user can download the requested file from a network, such as a local network or non-local network such as the Internet.

In a preferred embodiment, the files are transferred to the client machine readable medium 12 via a Transmission Control Protocol/Internet Protocol (TCP/IP protocol) which is a protocol for communication between machine readable medium, i.e., computers, used as a standard for transmitting data over networks and as the basis for standard Internet protocols. An IP protocol deals only with packets of data and a TCP enables two hosts to establish a connection and exchange streams of data. TCP provides delivery of data and also provides that packets of data will be delivered in the same order in which they were sent. The files are encrypted upon transfer and remain encrypted until they are deposited on the attachment server 16. Accordingly, the file transfer is preferably accomplished using the TCP/IP protocol. However, any suitable protocol may be used to achieve file transfer.

As detailed above, the user interface and user notification from the attachment server 16 is provided to the client machine readable medium 12 via email because the system 10 operates within the confines of email. Specifically, a link to downloaded files or information is sent via email to the client machine readable medium 12 as detailed above.

Also as detailed above, the client machine readable medium 12 invokes the attachment server 16 via the broker server 14. In another embodiment, when a client machine readable medium 12 is ready to upload files, the client machine readable medium 12 communicates with a broker server 14 from a plurality of broker servers and the broker server 14 finds an available attachment server 16 from a plurality of attachment servers. The attachment server 16 then sends the requested file or information to the client machine readable medium 12 and the client machine readable medium 12 then retrieves the files from the attachment server 16 as detailed above.

In a preferred embodiment, a user downloads requested files from a web server preferably using an HTTP protocol. Since the files are uploaded to a web server and not sent through email, only a link to the web server where the files are stored is included in the outgoing email to the client machine readable medium 12.

The system or apparatus and method 10 allow system administrators to specify the ports which are used for communication on the broker server 14 and the attachment server 16. In a preferred embodiment, the ports range available is from about 1 to about 65,500, based on the 16-bit address size available. All communication sockets on a machine need to have a single dedicated port, which will expire 60 seconds after application is done to allow the port to be reused by another application later. The delay ensures that any late data received by that port is not accidentally tagged with the new application using the port, causing collateral damage to other applications. The system administration determines which port is used for listening via configuration files, for both broker servers 14 and attachment servers 16. This allows for tighter security via firewalls and port lockdowns.

The system or apparatus and method 10 of the present invention provide benefits over other transfer systems. For example, in comparison to an FTP system, the system or apparatus and method 10 of the invention do not require a user to use FTP to upload and transfer files. The system or apparatus and method 10 of the invention allow users to use a personal information manager, preferably Microsoft® Outlook®, to transfer files in a seamless way without breaking the workflow.

Also for example, in comparison to Simple Mail Transfer Protocol (SMTP), the system or apparatus and method 10 of the present invention do not need to use SMTP because the files are not actually transmitted via email. With the system or apparatus and method 10 of the invention, the files are posted to a web server and then a link to those files is transferred via SMTP, i.e., email, to the client machine readable medium 12. The advantage of using the present system or apparatus and method 10 in this regard is that the files themselves are never actually transferred through the email server, but via a network.

While the system or apparatus and method have been described above as including a client machine readable medium 12, a broker server 14 and an attachment server 16, the system or apparatus and method 10 of the present invention may be practiced having any suitable number of client machine readable mediums, broker servers and/or attachment servers and fall within the scope of the invention.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A system for transferring files in a network including at least one machine readable medium, the system comprising:
at least one client machine readable medium adapted to prepare and issue a request for a file;
at least one broker server adapted to provide authorization to the request from the client machine readable medium and thereafter adapted to send the request for the file; and
at least one attachment server adapted to receive and store a plurality of files, wherein the attachment server is adapted to receive the request from the client machine readable medium via the broker server,
wherein the attachment server is adapted to send a transfer receipt to the client machine readable medium in response to the request, wherein the transfer receipt includes a link to the file requested by the client machine readable medium.

2. The system of claim 1, wherein the client machine readable medium is adapted to verify a user name and/or password with the broker server.

3. The system of claim 1, wherein the broker server is adapted to provide authorization to the request from the client machine readable medium when the broker server recognizes an identity of the client machine readable medium.

4. The system of claim 3, wherein the identity of the client machine readable medium includes a user name and/or password.

5. The system of claim 1, wherein the transfer receipt is sent from the attachment server to the client machine readable medium via an email.

6. The system of claim 1, wherein the client machine readable medium is adapted to invoke the attachment server via the link in the transfer receipt to transfer the file from the attachment server to the client machine readable medium.

7. The system of claim 6, further comprising a means adapted to communicate between machine readable mediums for transmitting data over a network and which is adapted to transfer the file to the client machine readable medium.

8. The system of claim 1, wherein the link in the transfer receipt is adapted to receive the file when downloaded through a network and to forward the file to the client machine readable medium.

9. The system of claim 1, wherein the client machine readable medium, the broker server and the attachment server are adapted to interact with each other and to work independently of each other.

10. The system of claim 1, wherein the client machine readable medium is adapted to send the request to the broker server and then to the attachment server by an email.

11. The system of claim 1, wherein the broker server includes a directory service for automating network management of user data and security, distributing resources and enabling interoperation with other directories.

12. The system of claim 1, further comprising a web server, including a hyper text transfer protocol, adapted to download the file requested and to send the file to the machine readable medium.

13. The system of claim 1, wherein the system includes more than one client machine readable medium, more than one broker server and/or more than one attachment server.

14. A method of transferring files in a network having at least one computer readable medium, the method comprising:
providing at least one client machine readable medium which prepares and issues a request for a file;
providing at least one broker server which provides authorization to the request from the client machine readable medium and thereafter sends the request for the file; and
providing at least one attachment server which receives and stores a plurality of files, wherein the attachment server receives the request from the client machine readable medium via the broker server,
wherein the attachment server sends a transfer receipt to the client machine readable medium in response to the request, wherein the transfer receipt includes a link to the file requested by the client machine readable medium.

15. The method of claim 14, wherein the authorization to the request from the client machine readable medium is upon recognition of an identity of the client machine readable medium by the broker server.

16. The method of claim 14, wherein the attachment server sends the transfer receipt to the client machine readable medium via an email.

17. The method of claim 14, wherein the client machine readable medium invokes the attachment server via the transfer receipt to transfer the file from the attachment server to the client machine readable medium.

18. The method of claim 14, wherein the file requested by the client machine readable medium is downloaded through a network and is received by the attachment server via the link in the transfer receipt.

19. The method of claim 14, wherein the request from the client machine readable medium is sent to the broker server and then to the attachment server by an email.

20. A method of transferring files in a network having at least one computer readable medium, the method comprising:
preparing and issuing a request for a file by a user;
authorizing the request and thereafter sending the request for the file; and
receiving the request for the file at a repository of files;
sending a transfer receipt to the user in response to the request, wherein the transfer receipt includes a link to the file requested by the user.

21. The method of claim 20, wherein the authorizing the request occurs following recognition of an identity of the user sending the request.

22. The method of claim 20, wherein the sending of the transfer receipt is by email.

23. The method of claim 20, further comprising transferring the file via the link in the transfer receipt from the repository to the user.

24. The method of claim 20, further comprising downloading the file requested by the user through a network and receiving the file via the link in the transfer receipt.

25. The method of claim 20, wherein the preparing and issuing of the request from the user occurs via an email.
